(19) United States
(12) Patent Application Publication
(10) Pub. No.: US 2021/0270540 A1
(43) Pub. Date: Sep. 2, 2021

(54) TEMPERATURE COMPENSATING ELEMENT, PIPE AND METHOD FOR PRODUCING A PIPE

(71) Applicant: Linde GmbH, Pullach (DE)

(72) Inventors: Manfred STEINBAUER, Raisting (DE); Konrad BRAUN, Lenggries (DE); Alexander WOITALKA, München (DE); Stefan GEWALD, Neuried (DE)

(21) Appl. No.: 17/258,683

(22) PCT Filed: Jul. 11, 2019
(86) PCT No.: PCT/EP2019/025226

§ 371 Date: Jan. 7, 2021

(30) Foreign Application Priority Data
Jul. 11, 2018 (DE) 10 2018 005 504.4

(51) Int. Cl. F28D 20/02

(52) U.S. Cl. CPC F28D 20/02; F28D 2020/0013

(57) ABSTRACT

The invention concerns a temperature compensating element (40) for a pipe (30), wherein the temperature compensating element (40) has at least one phase-change element (20) and can be inserted into the pipe (30) in such a way that the temperature compensating element (40) lies flat against an inside surface (32a) of a pipe casing (32) of the pipe (30) and that the phase-change element (40) is in thermal contact with the pipe (30), and wherein the temperature compensating element (40) forms a through-channel (22) along a running direction (100) of the pipe (30).

The invention relates to a temperature compensating element for a pipe; a pipe, in particular for a heat exchanger and/or a chemical reactor; a heat exchanger; a chemical reactor; and a method for producing a pipe. The invention is thus in particular in the technical field of heat exchangers or heat transmitters, in particular heat exchangers with straight and/or coiled pipes.

In the prior art, heat exchangers are known which have a plurality of pipes. One or more fluids may flow through the pipes, i.e., on the pipe side, so that a thermal contact with another fluid results via the pipe walls or pipe casings, which other fluid is arranged or flows outside of the pipes, i.e. on the casing side. The pipe-side fluids and the casing-side fluid may thereby have significantly different temperatures, so that a temperature gradient and thus a heat exchange results via the pipes or the pipe casings.

Especially given very pronounced temperature differences of the heat-exchanging fluids, large temperature gradients or temperature differences may arise at some components of the heat exchanger, such as at the pipes, and/or very significant temperature changes may occur in only a short period of time. This may lead to very large material stresses in the respective heat exchangers and/or in individual components of the corresponding heat exchanger, in particular in the pipes, and result in unwanted material fatigue. In particular, very large thermal stresses may occur at and near the inlet opening of a pipe, i.e. at and/or near the opening through which the pipe-side heat-exchanging fluid enters the pipe, since there the inflowing fluid typically has the highest or lowest temperature since the fluid is supplied to the heat exchange process for the first time upon entry of the fluid into the pipe. Therefore, the inlet regions of the pipes may be exposed most of all to very large temperature differences due to the fluid flowing into the pipes on the pipe side on the one hand and the fluid provided on the casing side for heat exchange on the other hand, which may consequently lead to large mechanical stresses of the pipe. For example, material fatigue, such as deformations and/or hairline cracks, may occur and may necessitate repair or even replacement of the pipe and/or the heat exchanger and/or chemical reactor.

In order to at least partially avoid unwanted thermal stresses in a pipe, external conditions are conventionally adapted in part in order, for example, to at least partially compensate and/or reduce the effects caused by a rapid temperature change. For example, inflow and/or outflow of fluids into the pipe or pipes may be adapted for this purpose. However, this has the disadvantage that often a very complex control technique is required for adapting these conditions, and/or that the heat exchanger and/or the chemical reactor requires other complex embodiments and/or components which increase the complexity of the heat exchanger or chemical reactor and/or increase the procurement costs and/or the maintenance costs of the heat exchanger or chemical reactor.

The use of phase-change elements is known in the prior art for use in coolers for electronic components, for example as disclosed in the publications EP 1162659 A2 and WO 2003046982 A1. The use of a phase-change element in a heat accumulator is also disclosed in the publication US 20170127557 A1. US 2011/0186169 A1 describes a pipe for an underwater pipeline having an insulating layer which is filled between an inner pipe and an outer pipe coaxial thereto, in particular in the form of a gel-like phase-change material.

The invention is therefore based on the object of providing or adapting a pipe for a heat exchanger and/or for a chemical reactor in such a way that the disadvantages inherent to the pipes known in the prior art are at least partially eliminated. In particular, the invention is based on the object of providing a pipe which experiences fewer negative effects as a result of thermal stresses.

The invention is achieved by a temperature compensating element for a pipe, a pipe, a heat exchanger, a chemical reactor, and a method for producing a pipe having the features of the respective independent claims. Preferred embodiments result from the dependent claims and from the following description.

In a first aspect, the invention relates to a temperature compensating element for a pipe, wherein the temperature compensating element has at least one phase-change element and can be inserted into a pipe in such a way that the temperature compensating element lies flat against an inside surface of a pipe casing of the pipe and that the phase-change element is in thermal contact with the pipe. The temperature compensating element thereby forms a through-channel along a running direction of the pipe.

In a further aspect, the invention relates to a pipe having a temperature compensating element according to the invention.

In a further aspect, the invention relates to a pipe having a pipe casing which comprises a cavity enclosed by the pipe casing. The pipe further has a phase-change element which is arranged within the cavity in the pipe casing such that the phase-change element is at least partially in thermal contact with the pipe casing.

In further aspects, the invention relates to a heat exchanger and a chemical reactor respectively having at least one pipe according to the invention.

In a further aspect, the invention relates to a method for producing a pipe. The method comprises producing a pipe casing such that the pipe casing has a cavity enclosed by the pipe casing, and arranging a phase-change element in the cavity in the pipe casing such that the phase-change element is at least partially in thermal contact with the pipe casing.

The fact that the temperature compensating element can be inserted into a pipe thereby means that the temperature compensating element can be arranged at least partially inside the pipe. For example, this may occur by sliding and/or pressing the temperature compensating element into the pipe in such a way that the temperature compensating element is in mechanical contact with an inside of the pipe casing. For this purpose, the temperature compensating element may preferably be adapted, with regard to its design and/or its dimensions, to the pipe into which the temperature compensating element is to be inserted. For example, for this purpose a cross-sectional shape of the temperature compensating element may substantially correspond to a cross-sectional shape of the inside of the pipe casing, and/or a cross-sectional dimension, for example a diameter, of the temperature compensating element may substantially correspond to a dimension of the inside of the pipe casing, for example the inner diameter. The fact that the temperature compensating element is connected flat to the pipe means that the temperature compensating element is connected to the pipe not only at points and/or along a line or edge, but has a two-dimensional and in particular significant contact surface with the pipe. In other words, the temperature compensating element preferably lies against the inside of the pipe over a large area. The temperature compensating element is preferably in thermal and mechanical contact with at least a part of the inside or inner surface of the pipe so that an efficient heat exchange may take place between the temperature compensating element or phase-change element and the pipe casing. According to another preferred embodiment, the temperature compensating element may have an adaptable and/or flexible shape in order to be able to adapt and/or to adjust to the inner dimensions of the pipe. The temperature compensating element preferably comprises a casing which forms a cavity, wherein the phase-change element is arranged in the cavity and is in thermal contact with the casing.

The fact that the temperature compensating element is in contact with the pipe thereby means that the temperature compensating element is in thermal contact and preferably in mechanical contact with the pipe. Mechanical contact thereby means in particular that the temperature compensating element and the pipe touch and preferably have a significant contact surface or contact area with one another. Thermal contact thereby means that a heat exchange, preferably a direct heat exchange, is possible between the temperature compensating element and the pipe.

The fact that the temperature compensating element, when inserted into the pipe, forms a through-channel along the running direction of the pipe thereby means that the temperature compensating element inserted into the pipe does not completely seal the pipe, but rather enables the flow of fluid through the pipe as before. Although the inserted temperature compensating element may reduce a remaining inner dimension of the pipe, in particular the inner diameter which is then available, it does not completely seal the pipe. This is necessary so that the pipe may continue to fulfill its function as a fluid transport channel, for example in a heat exchanger and/or a chemical reactor. The running direction of the pipe is thereby the direction in which a longitudinal axis of the pipe and in particular of the pipe casing extends. In other words, the running direction of the pipe runs perpendicular to the cross-sectional direction of the pipe, and thus corresponds to the direction in which a fluid can flow through the pipe.

Particularly advantageous is an embodiment of the temperature compensating element in the form of a pipe or pipe element, which for its part lies flat against at least one segment of the inside surface of the pipe casing of the (heat exchanger) pipe into which it can be inserted. In particular, “can be inserted” means here that the tubular temperature compensating element can be installed subsequently and reversibly in the pipe, thus forms a removable unit.

The phase-change element preferably has a phase-change material and/or is designed as a latent heat accumulator. In particular, a phase-change element preferably inherently has the property that the latent heat of fusion and/or heat of solution and/or heat of absorption of the phase-change element is significantly greater than the heat that the phase-change element can store due to its normal specific heat capacity, i.e. without occurrence of a phase transition effect. In other words, the phase-change element is designed to emit and/or absorb a greater amount of thermal energy in a phase transition than the amount of thermal energy that the phase-change element can store due without a phase transition to its specific heat capacity. The phase transition thereby preferably comprises a transition from the solid phase to the liquid phase and/or from the liquid phase to the solid phase. Alternatively or additionally, the phase transition preferably comprises a transition from a crystalline solid phase to an amorphous solid phase and/or from an amorphous solid phase to a crystalline solid phase.

The invention offers the advantage that, by providing a temperature compensating element in a pipe, a very large amount of heat can be absorbed or stored and/or a very large amount of stored heat can be emitted. In particular, a particularly rapid temperature change of the pipe, or of at least one such part of the pipe which has a temperature compensating element and/or is in thermal contact therewith, may thereby be slowed and/or reduced. Mechanical stresses in the pipe may thus be reduced or even completely avoided. The insertion of a temperature compensating element into a pipe is thus suggested, in particular in the vicinity of weld seams, for example where the pipe is or should be welded to a pipe bottom, in order to avoid a high thermal and/or mechanical load on the weld seam. The invention therefore has the advantage that thermal stresses, and in particular mechanical stresses resulting therefrom, at the contact points at which pipes are connected to the connection openings of the pipe bottom may be reduced and/or avoided. For example, weld seams by means of which the pipes are fastened to the pipe bottom or to the connection openings can be protected against damage due to strong thermal expansions.

The invention also offers the advantage that particularly large temperature gradients may be at least partially attenuated. An attenuation of the temperature gradient may thus also reduce or even completely avoid mechanical stresses in the pipe, and thus slow or prevent material fatigue.

Furthermore, the invention offers the advantage that the service life of pipes, and in particular of heat exchangers and/or chemical reactors equipped with pipes according to the invention, may be extended and/or wear on the pipe and/or heat exchanger and/or chemical reactor may be reduced. The invention also offers the advantage that maintenance work and/or maintenance costs may be reduced, since preferably a replacement of pipes which are conventionally very highly thermally stressed and/or maintenance of particularly stressed weld seams are no longer necessary or are still necessary only to a lesser extent.

The invention also offers the advantage that a failure susceptibility of a heat exchanger and/or a chemical reactor may be reduced in that pipes according to the invention are provided and/or pipes are provided with a temperature compensating element according to the invention. For example, the invention may offer the advantage that, given heat exchangers and/or given chemical reactors in which the casing-side fluid tends to solidify when the temperature drops, for instance given heat exchangers with water and/or glycol on the casing side, the solidification of the casing-side fluid may be slowed and/or avoided. For example, given a failure of the casing side, i.e. if a flow or a supply and/or discharge of the casing-side fluid is not ensured or is not ensured to a sufficient extent, ice formation on the casing side of the respective pipe and/or of the pipe bottom may thus be avoided at least partially and/or at least temporarily via the temperature compensating element, and the operation of the heat exchanger and/or chemical reactor may be maintained at least temporarily. Furthermore, damage which conventionally occurs as a result of a spatial expansion of the casing-side fluid during the formation of ice may thereby be reduced and/or avoided and/or delayed.

In addition, the invention offers the advantage that, according to the invention, a pipe may already be produced with a phase-change element. The pipes may thereby be provided in the same manner as conventional pipes and, for example, be installed in a heat exchanger and/or in a chemical reactor. The production cost for a heat exchanger and/or chemical reactor according to the invention may thereby preferably be reduced.

The production of the pipe casing preferably takes place by means of an additive manufacturing method. In particular, the production of the pipe or the pipe casing may take place by means of a 3D printer. For example, the production of the pipe casing and the arrangement of the phase-change element may thereby temporally overlap at least partially. This means that the phase-change element is at least partially arranged in the cavity formed in the pipe casing before the production of the pipe casing is concluded.

The temperature compensating element preferably has a tubular pipe insert or is formed as such and may be inserted into the pipe in such a way that the temperature compensating element tapers an internal dimension of the pipe. In other words, the temperature compensating element itself is preferably designed as a pipe and may, for example, be inserted or slid, in particular reversibly, into the pipe as a temperature compensating element. For this purpose, an external dimension of the temperature compensating element is particularly preferably adapted to a dimension of the inside of the pipe. For example, the pipe may have a round recess and the temperature compensating element may likewise have a round cross-sectional shape, and the temperature compensating element may be adapted in its outer diameter to the inner diameter of the pipe. This offers the advantage that the temperature compensating element may be particularly simply inserted into the pipe.

For reversible insertion of the tubular temperature compensating element into the (heat exchanger) pipe, the temperature compensating element advantageously has fastening and/or clamping elements which enable a mechanically stable but releasable connection of the temperature compensating element to the inside of the pipe. Such fastening elements may in principle be based on screwing or adhesive bonding or, for example, comprise a hook which is attached to a pipe end and to which is connected, further downstream, that part of the temperature compensating element in the inside of the pipe which comprises the phase-change element. For example, a clamping element is formed by a spring element extending coaxially to the inside of the pipe, which spring element presses against the inside of the pipe with a prestress in the radial direction in order to place the temperature compensating element so as to be as stationary as possible.

According to a further preferred embodiment, the temperature compensating element has a funnel-shaped pipe insert with one wider end and one narrower end or is formed as such and can be inserted into one of the openings of the pipe such that the wider end of the funnel-shaped pipe insert protrudes from an opening of the pipe. The wider end may thereby be wider than the narrower end with regard to its external dimensions and/or with regard to the through-channel. This offers the advantage that a filling of fluid into the opening of the pipe which is equipped with the funnel-shaped temperature compensating element may be simplified.

The temperature compensating element preferably lies flat against the inside surface of the pipe casing in such a way that at least 10%, preferably at least 20%, more preferably at least 30%, even more preferably at least 40%, more preferably at least 50%, most preferably at least 60% of the inside surface of the pipe casing is in direct mechanical contact with the temperature compensating element. This offers the advantage that in particular those regions of the pipe in which particularly strong and/or rapid temperature changes are to be expected may be provided with a temperature compensating element, whereas preferably other regions of the pipe do not necessarily need to be provided with a temperature compensating element.

It is to be understood that the features mentioned above and below may be used not only in the particular combination specified, but also in other combinations or by themselves, without departing from the scope of the present invention.

The invention is schematically illustrated in the drawings using exemplary embodiments and is described in the following with reference to the drawings.

### DESCRIPTION OF FIGURES

FIGS. 1A and 1B show, in a longitudinal or cross-sectional view, a pipe in accordance with a preferred embodiment.

FIGS. 2A and 2B show, in a longitudinal or cross-sectional view, a temperature compensating element in accordance with a preferred embodiment which is inserted into a conventional pipe.

FIG. 3 shows in a diagram an example of a curve of the temperature in various pipes.

### DETAILED DESCRIPTION OF FIGURES

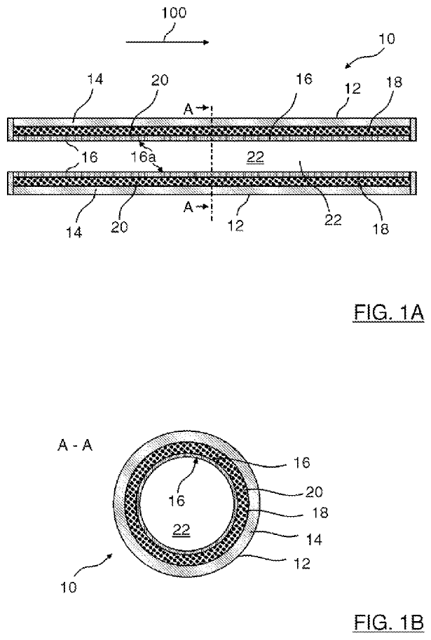

FIGS. 1A and 1B show, in a longitudinal or cross-sectional view, a pipe 10 in accordance with a preferred embodiment, in particular for a heat exchanger and/or for a chemical reactor. FIG. 1A shows the pipe 10 in a longitudinal sectional view, and FIG. 1B shows said pipe 10 in cross-sectional view along the line A-A (see FIG. 1A).

The pipe 10 has a pipe casing 12 which, according to the shown embodiment, extends in the running direction 100 and has an outer wall 14 and an inner wall 16 which enclose a cavity 18 situated between them. In other words, the pipe casing 12 is formed double-walled, with an inner wall 16 and an outer wall 14. A phase-change element 20 is thereby arranged in the cavity 18 formed in the pipe casing 12, in such a way that the phase-change element 20 is in thermal contact with the pipe casing 12 in a planar manner. According to the shown embodiment, the phase-change element 20 is arranged along the entire length of the pipe 10, so that the temperature-compensating effect of the phase-change element 20 is likewise available over the entire length of the pipe 10. At the ends of the pipe casing 12, the cavity 18 is sealed to prevent the phase-change element 20 from escaping from the cavity 18 and/or to prevent contaminants and/or foreign bodies from entering.

According to the shown embodiment, the outer wall 14, the inner wall 16, and the cavity 18 situated between them extend over the entire length of the pipe 10 along the running direction 100. However, according to other preferred embodiments, only a part or a segment of the pipe 10 may be provided with a phase-change element 20, whereas, for example, the remaining segments of the pipe 10 may be formed with a solid pipe casing 12, i.e. with a pipe casing which is not double-walled and has no cavity. In order to ensure a good thermal conductivity, however, the pipe casing 12 should have no segments in which an unfilled cavity is formed, since these could have a thermally insulating effect and could therefore be disadvantageous.

Located inside the pipe 10 is a through-channel 22 which is delimited by the inside or inside surface 16a of the inner wall and through which a fluid may flow, for example for heat exchange in a heat exchanger and/or in a chemical reactor. The inner diameter of the pipe 10 is thereby reduced so that only the through-channel 22 remains for the flow of the fluid through the pipe 10. In contrast, the phase-change element 20 enables a reduction or slowing of rapid temperature changes. The use of such pipes 10 may be particularly advantageous in heat exchangers and/or in chemical reactors in which exceeding and/or falling below a predetermined temperature is to be avoided, for example since ice otherwise forms. This may also offer the advantage that the pipe-side fluid and/or the casing-side fluid may be brought as close as possible to a predetermined limit temperature, and nevertheless it may be prevented that this limit temperature is exceeded or fallen below since the phase-change element 20 increases a thermal inertia of the pipe 10 and thus may prevent the limit temperature from being rapidly exceeded and/or fallen below.

As is apparent in FIG. 1B, the phase-change element 20 is arranged over the entire circumference of the pipe casing 12 so that the temperature-compensating effect of the phase-change element 20 may be utilized in all directions and no unwanted temperature gradients occur in the circumferential direction of the pipe casing 12. The pipe according to the shown embodiment has a round cross-sectional shape. However, according to other embodiments, other cross-sectional shapes are also possible, for instance elliptical and/or polygonal cross-sectional shapes, for example three, four, six, or. Furthermore, the cross-sectional shapes of the inner wall 16 and the outer wall 14 may be identical, as in the shown embodiment, or may differ from one another according to other embodiments. For example, the cross-sectional shape of the outer wall 14 may be polygonal, whereas the cross-sectional shape of the inner wall 16 may be round.

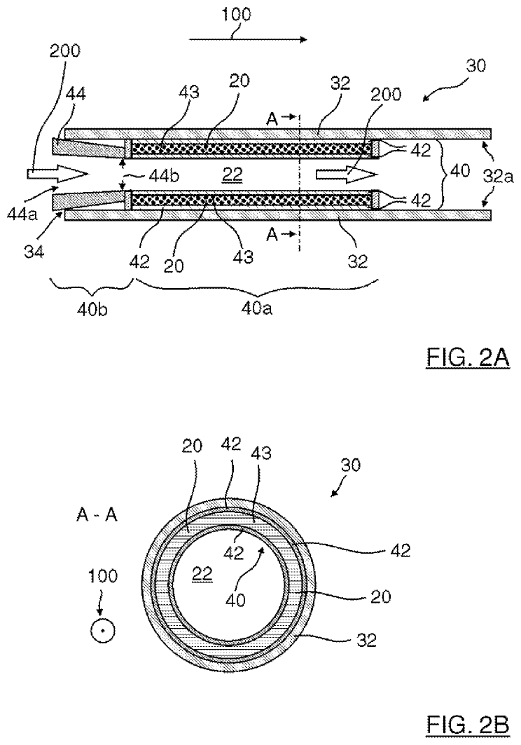

FIGS. 2A and 2B show, in a longitudinal or cross-sectional view, a conventional pipe 30 into which a temperature compensating element 40 according to a preferred embodiment is inserted.

The pipe 30 may be designed as a conventional pipe, for example for a heat exchanger and/or for a chemical reactor, and may have a simple and in particular single-walled pipe casing 32. A temperature compensating element 40 according to a preferred embodiment is inserted into the pipe 30, which temperature compensating element 40 runs a portion of the length of the pipe 30 in a segment along the running direction 100 and in this segment provides a temperature compensating effect.

The temperature compensating element 40 has a double-walled casing 42 which encloses a cavity 43 in which a phase-change element 20 is arranged. The tubular casing 42 is sealed at the end faces, i.e. at the terminating sides in the running direction, in order to prevent the phase-change element 20 from escaping and/or contaminants and/or foreign bodies from entering. The tubular segment 40a of the temperature compensating element 40 tapers the inner dimension of the pipe casing 32 or reduces the inner diameter of the pipe casing 32 so that, in the tubular segment 40a of the temperature compensating element 40, there remains a through-channel 22 which is smaller than the regular channel or inner diameter of the pipe casing.

Furthermore, in segment 40b the temperature compensating element 40 according to the shown preferred embodiment has a funnel-shaped pipe insert 44 which serves as a filler neck which is fixedly connected to the tubular segment 40a of the temperature compensating element 40. According to the shown preferred embodiment, the funnel-shaped pipe insert 44 or the segment 40b has no phase-change element 20, although this is possible according to other preferred embodiments. The funnel-shaped pipe insert 44 protrudes from an opening 34 of the pipe 30 and serves to facilitate the supplying or filling of a fluid in the flow direction 200 into the pipe 30 or the tapered through-channel 22, in that the wider end 44a of the funnel-shaped pipe insert 44 protrudes from or faces toward the opening 34, whereas the narrower end 44b is connected to the through-channel 22 and preferably coincides with its dimensions.

With a temperature compensating element 40 according to this shown embodiment, a conventional pipe 30 can thus advantageously be supplemented with a temperature compensation function. The temperature compensating element 40 may thereby be provided during the production of the pipe 30 and/or be subsequently inserted into a pipe 30.

FIG. 2B shows the pipe 30 and the temperature compensating element 40 in a schematic cross-sectional presentation, wherein the cross section is along line A-A (see FIG. 2A). It is thereby apparent that the shape and dimension of the temperature compensating element 40 is adapted to the inside 32a of the pipe casing 32 and is in mechanical and thermal contact with said inside 32a in a planar manner. Furthermore, it is apparent in FIG. 4B that the temperature compensating element 40, and in particular the phase-change element, extends along the entire circumferential direction of the pipe casing 32.

According to the shown embodiment, the temperature compensating element 40 does not extend over the entire length of the pipe 30, but rather only over a shorter length beginning at the end or the opening 34 of the pipe 30 at which the pipe-side fluid flows into the pipe 30. This may be sufficient since, given a heat exchange that has already partially taken place at the beginning of the pipe 30, the temperature difference between the pipe-side fluid and the casing-side fluid is less than upon the pipe-side fluid flowing into the pipe 30

This embodiment offers the advantage that an already existing pipe 30 may be retrofitted with a temperature compensating element 40 in a simple manner.

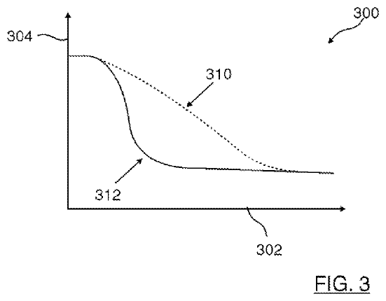

FIG. 3 schematically shows, in a diagram 300, an example of a curve of the temperature (axis 304) versus the time (axis 302) of a pipe having a temperature compensating element 40 or having a phase-change element 20 (graph 310) as compared to the temperature curve of a pipe without a temperature compensating element 40 and without a phase-change element (graph 312), when this is exposed to a strong temperature change acting on it from the outside. It is thereby apparent that the temperature of the pipe with the temperature compensating element 40 or the with phase-change element changes significantly slower and more continuously than is the case given the pipe without a temperature compensating element and without a phase-change element 20. Thermal and mechanical stresses on the pipe may thereby be reduced via the introduction and/or attachment of a phase-change element 20 or temperature compensating element 40.

### REFERENCE NUMBERS

10 Pipe

12 Pipe casing

14 Outer wall of the pipe casing

16 Inner wall of the pipe casing

16 Inside of the inner wall

18 Cavity

20 Phase-change element

22 Through-channel

30 Conventional pipe

32 Pipe casing

32a Inside of the pipe casing

40 Temperature compensating element

40a Tubular segment of the temperature compensating element

40b Funnel-shaped segment of the temperature compensating element

42 Casing

43 Cavity

44 Funnel-shaped pipe insert

44a Wider end of the funnel-shaped pipe insert

44b Narrower end of the funnel-shaped pipe insert

100 Running direction

200 Flow direction

300 Diagram

302 Time axis

304 Temperature axis

310 Graph (temperature curve with phase-change element)

312 Graph (temperature curve without phase-change element)

1. Temperature compensating element (40) for a pipe (30), wherein the temperature compensating element (40) has at least one phase-change element (20) and can be inserted into the pipe (30) in such a way that the temperature compensating element (40) lies flat against an inside surface (32a) of a pipe casing (32) of the pipe (30) and that the phase-change element (40) is in thermal contact with the pipe (30), and wherein the temperature compensating element (40) forms a through-channel (22) along a running direction (100) of the pipe (30).

2. Temperature compensating element (40) according to claim 1, wherein the temperature compensating element (40) has a tubular pipe insert or is formed as such and can be inserted into the pipe (30) in such a way that the temperature compensating element (40) tapers an inner dimension of the pipe (30).

3. Temperature compensating element (40) according to claim 1, wherein the temperature compensating element (40) can be reversibly inserted into the pipe (30) and forms a unit which can be removed from the pipe (30).

4. Temperature compensating element (40) according to claim 3, wherein the temperature compensating element (40) has fastening and/or clamping elements for reversible insertion, which fastening and/or clamping elements establish a releasable connection of the temperature compensating element to the inside of the pipe (30).

5. Temperature compensating element (40) according to claim 1, wherein the temperature compensating element (40) has a funnel-shaped pipe insert (44) with one wider end (44a) and one narrower end (44b), or is formed as such, and can be inserted into one of the openings (34) of the pipe (30) such that the wider end (44a) of the funnel-shaped pipe insert (44) protrudes from the opening (34) of the pipe (30).

6. Temperature compensating element (40) according to claim 1, wherein the phase-change element (20) is designed to emit and/or absorb a greater amount of thermal energy in a phase transition than the amount of thermal energy that the phase-change element (20) can store without a phase transition due to its specific heat capacity.

7. Temperature compensating element (40) according to claim 6, wherein the phase transition comprises a transition from the solid phase to the liquid phase and/or from the liquid phase to the solid phase and/or from a crystalline solid phase to an amorphous solid phase and/or from an amorphous solid phase to a crystalline solid phase.

8. Temperature compensating element (40) according to claim 1, also comprising a casing (42) which forms a cavity (43), wherein the phase-change element (20) is arranged in the cavity (43) and is in thermal contact with the casing (42).

9. Pipe having a temperature compensating element (40) according to claim 1.

10. Pipe (10) having:
a pipe casing (12) which comprises a cavity (18) enclosed by said pipe casing (12);
a phase-change element (20) which is arranged within the cavity (18) in the pipe casing (12) such that the phase-change element (20) is at least partially in thermal contact with the pipe casing (12).

11. Heat exchanger having at least one pipe (10) according to claim 9.

12. Chemical reactor having at least one pipe (10) according to claim 9.

13. Method for producing a pipe (10), comprising the steps of:
producing a pipe casing (12) in such a way that the pipe casing (12) has a cavity (18) enclosed by said pipe casing (12);
arranging a phase-change element (20) in the cavity (18) in the pipe casing (12) such that the phase-change element (20) is at least partially in thermal contact with the pipe casing (12).

14. Method according to claim 13, wherein the production of the pipe casing (12) and the arrangement of the phase-change element (20) temporally overlap at least partially, and/or wherein the production of the pipe casing (12) takes place by means of an additive manufacturing method.
